(19) United States
(12) Patent Application Publication
(10) Pub. No.: US 2016/0247522 A1
(43) Pub. Date: Aug. 25, 2016

(54) METHOD AND SYSTEM FOR PROVIDING ACCESS TO AUXILIARY INFORMATION

(71) Applicant: ALCATEL LUCENT, Boulogne-Billancourt (FR)

(72) Inventors: Vinay Namboodiri, Antwerp (BE); Donny Tytgat, Antwerp (BE); Maarten Aerts, Antwerp (BE); Sammy Lievens, Antwerp (BE)

(73) Assignee: Alcatel Lucent, Boulogne Billancourt (FR)

(21) Appl. No.: 15/031,787

(22) PCT Filed: Oct. 28, 2014
(86) PCT No.: PCT/EP2014/073068

§ 371 Date: Apr. 25, 2016

(30) Foreign Application Priority Data
Oct. 31, 2013 (EP) 13306487.3

(51) Int. Cl. G10L 25/54; G10L 15/26; G06F 17/30; H04L 29/06

(52) U.S. Cl. CPC G10L 25/54; H04L 65/403; H04L 65/1089; G10L 15/26; G06F 17/30719; G06F 17/30619

(57) ABSTRACT

The invention relates to a system and method for tag based access to auxiliary information during a video- and/or audio-conference. The system comprises a mapping between tags and associated portions of auxiliary information. The method may comprise transmitting video data and/or or audio data from the video- and/or audio-conferencing system to participants of the video-conference. During the transmission tags may be extracted from the video data and/or audio data. As soon as a request for auxiliary information is received from a participant, the method may comprise selecting at least one of the tags extracted from the transmitted video data and/or audio data, retrieving at least one auxiliary information portion associated with the selected at least one tag, and transmitting the at least one retrieved auxiliary information portion to the participant that has requested the auxiliary information.

### FIELD OF INVENTION

The invention relates to a method and system for access to auxiliary information in a video- and/or audio-conference.

### BACKGROUND

A video- and/or audio conference is a conference in which participating device or participants (for instance, communication devices such as desktop computers and/or mobile devices such as laptops, smart phones, etc.) in different locations are able to communicate with each other in sound and vision. The communication can be point-to-point, for instance from the organizer of the conference (i.e. the video- and/or audio conferencing system) to one participant (unidirectional) or between the organizer and the participant (bidirectional). The communication may also involve several (multipoint) sites at multiple locations enabling multidirectional communication. Each participant may be serving one or more users.

During such conference, users may need auxiliary information to better comprehend the content of the communication. For example, in technical meetings the video or audio may contain technical terms that are not common knowledge to the recipient (i.e. the user of the participating device). In these cases it would be helpful for the user to receive auxiliary information from the video- and/or audio conferencing system. For instance, it may be helpful for the user to receive a diagram that can be used as reference, a technical definition of technical terms or keywords used in the conference, etc.

It is an object of the present invention to provide a method and system for improving the user's comprehension of the content of an audio- and/or video conference.

### SUMMARY

According to a first aspect of the invention this object may be achieved in a method for tag based access to auxiliary information during a video- and/or audio-conference, the video- and/or audio conference involving a video- and/or audio conferencing system comprising a mapping between tags and associated portions of auxiliary information, the method comprising:
transmitting video data and/or or audio data from the video- and/or audio-conferencing system to participants of the video-conference;
extracting tags from the video data and/or audio data being transmitted;
upon receiving a request for auxiliary information from a participant:
selecting at least one of the tags extracted from the transmitted video data and/or audio data;
retrieving at least one auxiliary information portion associated with the selected at least one tag;
transmitting the at least one retrieved auxiliary information portion to the participant that has requested the auxiliary information.

The auxiliary information may be displayed on the participant's rendering device so that the information is readily available. By providing the participant (and therefore the user) with access to this auxiliary information during a conference and in a seamless manner through the use of tags (i.e. visual tags and/or audio tags), the conferencing experience may be increased considerably. Suppose the user needs access to auxiliary information then the system extracts relevant tags from audio and/or video and then based on a mapping provides access to the auxiliary information.

Another way of providing auxiliary information would be for each user to explicitly access the browser on his communication device and look for the auxiliary information on the internet. This is in terms of explicit “pull” by the user. However, this may require a considerable effort and time and may reduce the contribution of the users during the conference. Another option for providing the auxiliary information may be to push the auxiliary information to all of the participants, for instance the peripheral devices of their users. However, the information may not be useful to each user or it may distract (other) users from the conference. According to aspects of the invention each of the participants may be presented with auxiliary information that is specifically requested by the individual participant.

In embodiments of the invention the method comprises transmitting the at least one retrieved auxiliary information portion only to the participant that has requested the auxiliary information. An advantage is that other participants not having requested auxiliary information or having requested different auxiliary information are not bothered with receiving auxiliary information that is not relevant to them. In other embodiments, however, the method comprises transmitting this auxiliary information not only to the requesting participant, but also to one or more of the other participants.

In a further embodiment the method comprises:
registering a peripheral device of a participant to the video- and/or audio-conferencing system;
transmitting the at least one retrieved auxiliary information portion to the registered peripheral device.

Registration of the participant makes it easier for the video- and/or audio conferencing system to identify which participant has requested which auxiliary information, so that it may determine to send each participant suitable for only that participant.

Preferably the time lapse between the receipt of specific items in the audio or video data and the transmitting auxiliary information about the items is relatively short, for instance 10 seconds or less, so that the participant (once a request has been transmitted from the participant to the conferencing system) is provided at an early stage with relevant information.

As described above, the conferencing system comprises a mapping between tags and associated portions of auxiliary information. This mapping is generated in a preprocessing phase. The pre-processing phase of the method may comprise receiving at least one structured text document with tags and their associated auxiliary information portions. Such document may have been annotated by the person hosting the video-conference and may be loaded onto the conferencing system and stored on its storage medium. Alternatively or additionally the method may comprise:
receiving auxiliary information by the video- and/or audio-conferencing system;
processing the received auxiliary information for obtaining one or more tags from the auxiliary information;
mapping the obtained one or more auxiliary information tags to one or more associated portions of the auxiliary information.

Based on potentially useful auxiliary information received from various participants and/or from any other source, the method may involve an automatic generation of tags and an automatic mapping of the generated tags with the associated information portions. Examples of such other sources are previous presentations, in-company technical information, handbooks, encyclopedia, and online available knowledge sources. In embodiments of the invention. The collection of auxiliary information, the retrieval of the tags and the generating of a mapping between the tags and the relevant portions of auxiliary information may therefore be performed automatically and in principle do not need user intervention.

In an embodiment of the invention the processing of auxiliary information comprises applying text parsing and/or text summarization to the auxiliary information. These processing operations may result in tags and their associated text portions of auxiliary information (i.e. the portions of the texts that are related to the tags).

In an embodiment the parsing of auxiliary information comprises:
obtaining text segments from the auxiliary information;
scoring the potential for each text segment to be a tag;
selecting one or more tags from the scored text segments;
determining information portions representative of the meaning of the selected tags.

Scoring the potential of text segments to be tags may be based on a variety of text parsing techniques, for instance techniques based on text segment (term)-frequency and/or inverse document frequency.

In an embodiment of the invention the processing of auxiliary information comprises collating tags by comparing the tags with a pre-stored compendium to augment the tags with synonyms and root forms. The compendium may be any source, for instance a WordNet 0 database. These synonyms and root forms may constitute further tags that are being mapped to the relevant information portions. In other embodiments the tags are roots forms only. Consequently, if synonyms or root forms are present in the conference data (i.e. in the video data and/or audio data), relevant items are recognized more easily so that the participant is presented with highly relevant auxiliary information.

In an embodiment of the invention the processing of auxiliary information comprises storing the tags and the mapping with auxiliary information portions in a tag index, preferably storing the tags in at least one tag index file on the video- and/or audio-conferencing system. In this way the knowledge is readily accessible for the actual and future conferences. The tag index file may comprise a lexigraphic table for easy access on lookup.

In the deployment phase, i.e. the phase after the pre-processing phase, the extracting of tags from the audio data being transmitted may comprise applying a speech recognition process to the audio data to obtain text segments from the audio data, and retrieving one or more tags from the recognized text segments. Similarly the extraction of tags from the video data being transmitted may comprise applying a text recognition process to the video data to obtain text segments from the video data, and retrieving one or more tags from the recognized text segments.

The method may comprise recognizing text segments from the audio data and retrieving tags from the recognized text segments. Herein text segments may be any of a word, word root and a combination of words.

In embodiments of the invention the extraction of tags, more specifically the speech recognition and retrieval of tags, is performed during data transmittal of the video- and/or audio data to the participant. In other words, the extracting of tags may be performed on the fly. In other embodiments the extracting of tags are performed just before (or just after) the video/audio data are transmitted to the applicant. Preferably the method provides the tags to the participant at the same moment as or a few seconds after the actual video/data are generated and/or transmitted to the participant so that the user may be presented with the relevant auxiliary information without delay.

In embodiments of the invention the retrieving of tags from the recognized text segments from the video- and/or audio data comprises:
comparing the recognized text segments from the processed audio and/or video data with the tags of the mapping;
determining one or more tags corresponding to one or more of the recognized text segments;
determining for each tag the associated auxiliary information portion or portions from the stored mapping.

In these embodiments only tags that in the preprocessing phase have been derived from the auxiliary information are retrieved from the recognized text segments of the conference data. In other embodiments tags are retrieved from the text segments of the conference data irrespective of the tags previously being derived in the preprocessing phase. The retrieved tags derived from the conference data are then compared to the tags derived from the auxiliary information. Only the conference data tags that correspond to the auxiliary information tags are then selected to be used collect the auxiliary information that is to be pushed to the participant.

In embodiments of the invention the method comprises:
transmitting video data and/or audio data from the video- and/or audio-conferencing system to a first rendering device of a participant;
transmitting auxiliary information from the video- and/or audio-conferencing system to a second rendering device of the participant.

The first rendering device may be the computer device employed by the user(s) to participate in the conference. The second rendering device may be part of a peripheral device, for instance a mobile telecommunications device such as a telephone, smart phone or tablet device. In these embodiments the auxiliary information and the video/audio data are presented on separate displays, one for the actual video and/or audio of the video-conference and one for the auxiliary information. For instance, in case of more than one user employing the first rendering device, different user may need different auxiliary information to be presented at different moments in time. By separating the data streams of the conference and the auxiliary information and forwarding the streams to separate display devices the auxiliary information may be customized to meet the needs of the specific user requesting the information. In other embodiments, however, both data streams are displayed on a single display device.

Once a user has requested auxiliary information through his peripheral device, the conference system starts selecting at least one of the tags extracted from the transmitted video data and/or audio data. The selecting may comprise determining the one or more tags extracted in a predefined time period before receipt of the request for auxiliary information. For instance, as soon as a request message has been received by the conference system, the system selects the tags that have been identified in the last n time frames (n is natural number≧1), finds for this set of tags the associated auxiliary information portions and pushes these portions to the peripheral device.

In further embodiments the selection of tags extracted from the transmitted video and/or audio data is based on participant preference (i.e. preference of the participant device and/or preference(s) of one or more peripheral devices of different users). For instance, a user may indicate in the participant preference that there is a relatively low level of knowledge about the subject of the conference. In this case a relatively high amount of auxiliary information is pushed to the peripheral device of the user. In case more the user already has a high knowledge level about the subject of the conference, less auxiliary information is pushed to the peripheral device so as to reduce the distraction to the user.

According to another aspect of the invention a system for tag based access to auxiliary information in a video- and/or audio conference is provided, the system comprising:
a storage unit configured to store auxiliary information, tags, and a mapping between the tags and associated portions of the auxiliary information;
a first transmitter for transmitting video data and/or or audio data to one or more participants of the conference;
a receiver for receiving a request for auxiliary information from one or more participants of the conference; p1 an extractor for extracting tags from the video data and/or audio data;
a retrieval unit for retrieving auxiliary information upon receipt of a request for auxiliary information by the receiver, the retrieval unit being configured to:
   select at least one of the tags extracted from the transmitted video data and/or audio data;
   retrieve at least one auxiliary information portion associated with the selected at least one tag;
a second transmitter for transmitting the retrieved auxiliary information portions to the participant that has requested the auxiliary information.

In embodiments of the invention the extractor is configured to apply a speech recognition process to the audio data to obtain text segments from the audio data and to retrieve one or more tags from the recognized text segments and/or to apply a text recognition process to the video data to obtain text segments from the video data and to retrieve one or more tags from the recognized text segments.

In embodiments of the invention the retrieval unit is configured to compare the recognized text segments from the processed audio and/or video data with tags from the stored mapping, to determine one or more tags corresponding to one or more recognized text segments and to determine for each tag the associated auxiliary information portion or portions from the mapping stored on the storage medium.

In embodiments of the invention the first transmitter is configured to transmit the video-and/or audio data to a first rendering device of the participant and the second transmitter is configured to transmit the retrieved auxiliary information portions to a second rendering device of the participant.

In embodiments of the invention the first and second rendering devices are combined into one rendering device and/or the first and second transmitters are combined into one transmitter. In embodiments of the invention the second rendering device is a peripheral device, more preferably a mobile telecommunications device, such as a telephone, smart phone or tablet device.

In embodiments of the invention the retrieval unit is further configured to select at least one of the tags extracted from the transmitted video data and/or audio data by determining the one or more tags extracted in a prestored time period before receipt of the request for auxiliary information.

In embodiments of the invention the retrieval unit is configured to compare a selected tag with a mapping between the tags and associated portions of the auxiliary information and to determine the one or more auxiliary information portions corresponding to the selected tag.

In embodiments of the invention the system is configured to:
rank the tags extracted from the video and/or audio data;
transmit the ranked tags to the participant;
receive from the participant a selection of the ranked tags;
retrieve the auxiliary information portion or portions from the selected tags.

In embodiments of the invention the system is configured to select tags extracted from the transmitted video and/or audio data based on participant preference. The preference may be transmitted by the participant device and/or by the participant peripheral device(s) to the conference system. The preference preferably may have been stored in a pre-processing phase of the stem and/or is determined by the participant's behaviour (for instance, depending on the number of times a peripheral device has requested auxiliary information).

In embodiments of the invention the number of tags selected from the tags extracted video and/or audio data depends on the number and/or the frequency of received requests for auxiliary information.

In embodiments of the invention the system comprises a pre-processing unit to perform the pre-processing as described herein. The pre-processing unit may be separate from the conference system or part of a monolithic architecture. The pre-processing unit may be configured to receive auxiliary information, process the received auxiliary information for obtaining one or more tags from the auxiliary information, mapping the obtained one or more auxiliary information tags to one or more associated portions of the auxiliary information and storing the auxiliary information, the tags, and the mapping between the tags and associated portions of the auxiliary information on the storage medium.

In embodiments of the invention the pre-processing unit is configured to:
apply text parsing and/or text summarization to the auxiliary information to obtain tags and their associated text portions of auxiliary information; and/or
collate tags by comparing the tags with a pre-stored compendium to augment the tags with synonyms and root forms; and/or
store the tags and the mapping with auxiliary information portions on the storage medium, preferably in a tag index or in at least one tag index file.

According to another aspect of the invention an assembly of the system as defined herein and one or more participants connected or connectable to the system through one or more telecommunication networks.

According to another aspect of the invention a computer program product is provided, wherein the product comprises code for performing the method defined herein, when run on an electronic device, such as a computer.

Further advantages, features and details of the present invention will be elucidated on the basis of the following description of some embodiments thereof. Reference is made in the following description to the figures, in which:

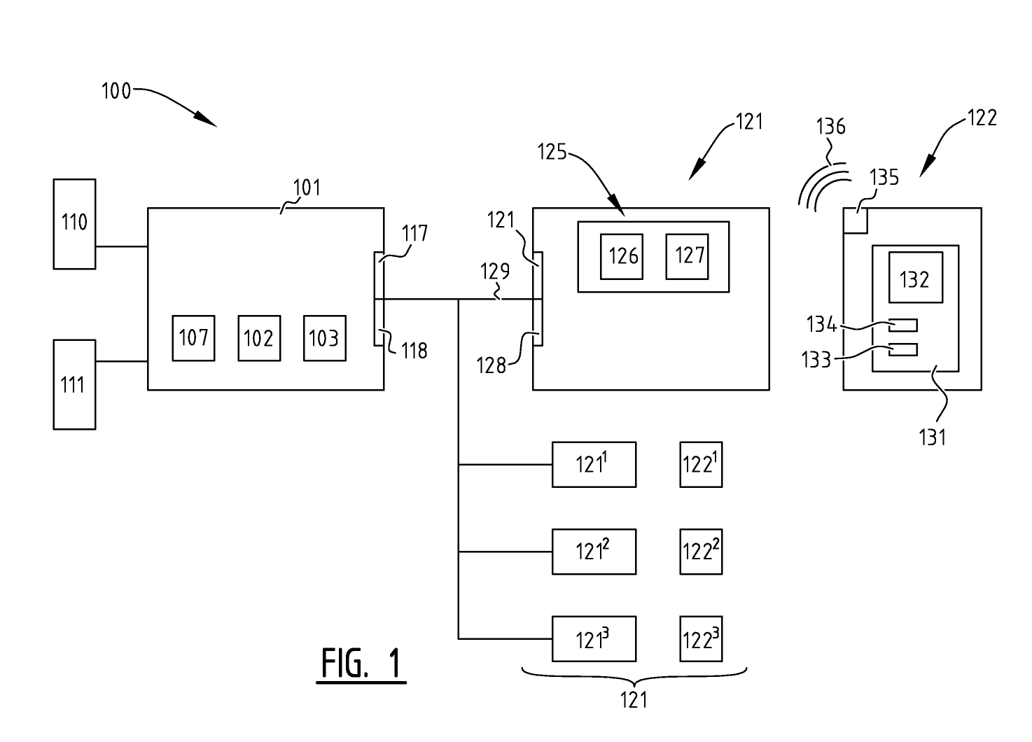

FIG. 1 shows a schematic overview of a first embodiment of system according to an embodiment of the present invention;

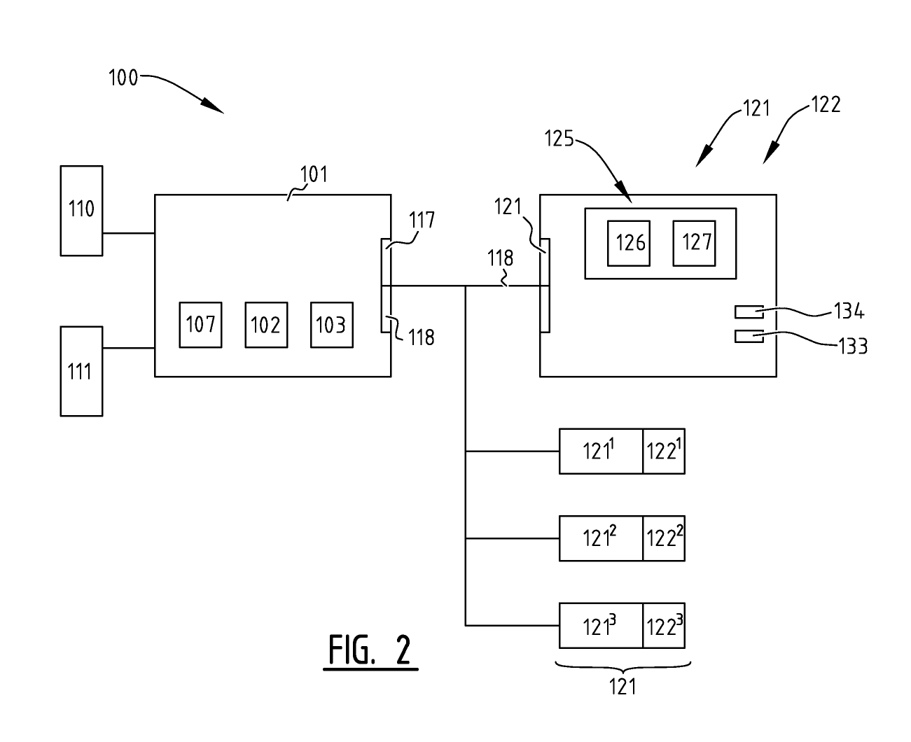

FIG. 2 shows a schematic overview of a second embodiment of system according to an embodiment of the present invention;

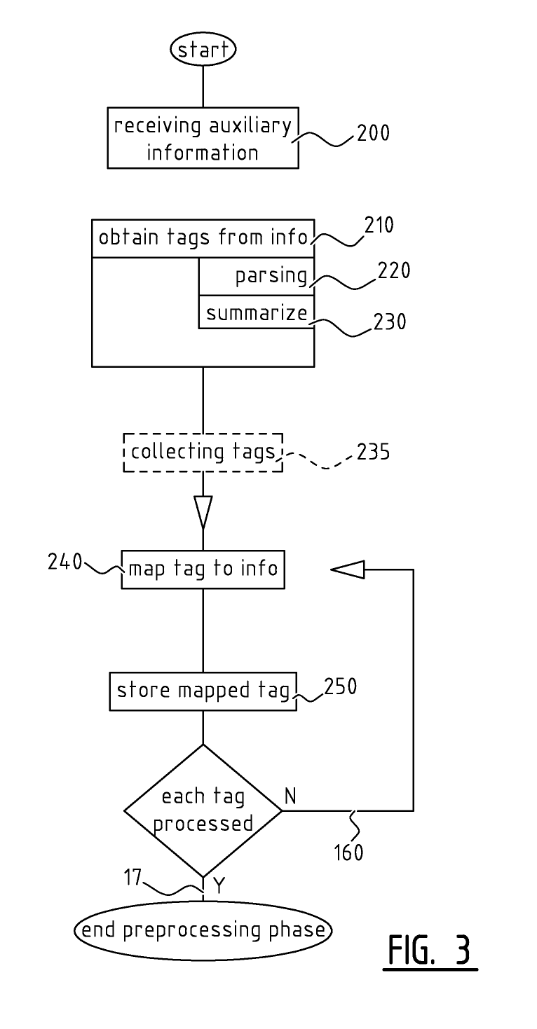

FIGS. 3-5 show a diagram of method steps according to an embodiment of the invention, wherein FIG. 3 represents the pre-processing phase and figured 4 and 5 the deployment phase.

### DESCRIPTION OF EMBODIMENTS

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Still, certain elements are defined below for the sake of clarity and ease of reference. Furthermore, the terms “system” and “computer-based system” refer to the hardware means, software means, and data storage means (e.g., a memory) used to practice aspects of the present invention. The minimum hardware of the computer-based systems of the present invention includes a central processing unit (CPU), input means, output means, and data storage means (e.g., a memory). A skilled artisan can readily appreciate that many computer-based systems are available which are suitable for use in the present invention.

With reference to FIG. 1, an exemplary system 100 for implementing the various aspects of the invention is shown. The video- and data conferencing system 100 (herein also referred to as the conferencing system) includes a conventional computer 101, including a processing unit 102, a system memory 103, and a system bus 104 that couples various system components, including the system memory, to the processing unit 102. The processing unit 102 may be any commercially available or proprietary processor. In addition, the processing unit may be implemented as a multi-processor including a plurality of processors. The system memory 103 may include read only memory (ROM) and random access memory (RAM). The system may comprise storage facilities 107, for instance one or more storage media such as hard discs, or at least connected to storage facilities, for instance online storage facilities. The operator can enter commands and information into the computer 101 through one or more user input devices, including, but not limited to, a keyboard 110 , a pointing device (e.g., a mouse 111), a touch screen, and a voice recognition system.

It is to be appreciated that the computer 101 can operate in a networked environment using logical connections to one or more participants 120-120³ of the conference. Each participant may comprise a remote computer. The participant 120 may be a workstation, a server computer, a router, a peer device or other common network node, and typically includes many or all of the elements described relative to the computer 101. The system may be connected to or include one or more communication networks 129, such as a local area network (LAN), a wide area network (WAN), and a telephone network, for instance a digital cellular network. In embodiments of the invention the system is connected to the internet. The system 100 comprises a transmitter 117 for transmitting video data and audio data over the communication networks 129 to the participants 120-120³ of the conference. The system also comprises a receiver 118 for receiving data, for instance an auxiliary request, from the participants.

In embodiments of the invention each participant 120 comprises a participant device 121-121³ and an peripheral device 122-122³. The peripheral device may be the mobile device 130-130³ of the user of the participant device, for instance a mobile telecommunication device such as a (smart) phone, PDA or a tablet. The participant device 121 comprises a receiver 124 for receiving data from the network 129 and a first rendering device 125 for rendering the video data and/or the audio data. Optionally the participant device 121 has a transmitter 128 as well. The rendering device may comprise a display 126 for displaying the video data and a loud speaker 127 for playing the audio data.

The respective mobile devices 130 comprise a transceiver 135 for receiving data from the network 136 or transmitting data over the network 136 (wherein the network 136 may be a wireless network, for instance a Wifi-network or a telephone network, or may be the network 129 between the participant device 121 and the system 100. A mobile device comprises a transceiver 124 for receiving data from the network 136, for instance the auxiliary information, and for sending data, for instance an auxiliary information request, over the network 136. The mobile device further comprises a second rendering device 131 for rendering the auxiliary information. The rendering device may comprise a display 132 for displaying the auxiliary information and a loudspeaker 133 for proving sound associated with the auxiliary information. The mobile device 130 comprises input means 134, for instance a key or a number of keys, to operate the device and to cause the device to send an auxiliary information request signal to the conference system 100.

FIG. 2 shows an embodiment of the present invention wherein the peripheral device 122 and the mobile device 130 of at least one of the users have been combined into participant device. The combined device may have one display only to render both the audio/video data and the auxiliary information on the same display and one set of transmitters/receivers or one transceiver to provide for data communication (both video/audio data and auxiliary information) between the conference system 100 and the participant device 121.

In a preprocessing phase, before setting up a conference between the conference system 100 and the participants 120, auxiliary information is loaded into the system 100 and stored on the storage 107. For instance, potential auxiliary information may be uploaded and stored by the various participants of the conference or may be stored by the presenter of the conference. Alternatively or additionally potential useful auxiliary information may be derived from in-company and/or external technical knowledge sources, for instance handbooks, previous presentations, reports, etc. In embodiments of the invention the auxiliary information is made available in structured text documents. The structured text documents contain text that provides auxiliary information about certain technical or non-technical items. A number of tags has been coupled or associated to the items. Each tag may be associated with one or more portions of the auxiliary information.

Additionally or alternatively, the auxiliary information may be available in unstructured form. Referring to FIG. 3, an embodiment is shown wherein the method comprises receiving (200) auxiliary information in the conference system 100 and processing the received auxiliary information for obtaining (210) a number of tags from the auxiliary information. Then a tag is mapped (240) with one or more suitable portions of the auxiliary information. The mapping is stored (250) on the storage facility 107 of the conference system 100. When not all tags have been processed, the mapping operation is repeated (260) for all the tags retrieved from the auxiliary information. When all tags have been processed and stored (270) on the storage facility 107 of the conference system 100, the conference system 100 is ready for the deployment phase wherein a conference may be organized. The mapping may be stored as a mapping index, for instance, relating each tag to one or more suitable portions (for instance, explanatory pieces of text) of auxiliary information.

In embodiments wherein the auxiliary information comprises text, optionally a combination of text and images or videos (with or without audio components), the text part of the auxiliary information may be processed to obtain an number of tags. Processing the text part of the auxiliary information may comprise applying text parsing (220) and/or text summarization (230). Text parsing results the auxiliary information text to be divided in individual text segments. In a further step a score is determined for the potential for the text segments to be tags, based on metrics such as TF (term-frequency) or IDF (inverse document frequency). The highest scoring text segments can then be annotated by associating tags based on their first usage. One of the possible heuristics is that (technical) terms are explained the first time they are used. Numerous alternative methods obtaining tags and associating the obtained tags with portions of the auxiliary information are conceivable as well and are all well within reach of the skilled person.

In further embodiments of the processing involves collating (235) tags by comparing the tags with a pre-stored compendium to augment the tags with synonyms and root forms in order to increase the reliability of the processing operation.

In the deployment phase the conference starts with the participant 120 to register (300) to the conference system 201. In embodiments wherein a participants 120 are comprised of a separate participant device 121 and a peripheral device 122, the method comprises registering (310) the participant device and registering (320) the peripheral device of the participant are registered to the video- and/or audio-conferencing system. This enables to system 100 to send the audio/video data to the first display of the participant device 121 and the auxiliary information to a separate (second) display device of the peripheral device 122.

As soon as the conference has started, video data and audio data are being transmitted (330) from the conferencing system 100 to the participant devices 121 of the participants 120. During the transmission of the data the conference systems processes the video/audio data in order to extract (340) a number of tags. The tags may be extracted from the video data by applying a text recognition process (350) to the video data to obtain text segments and by retrieving (360) one or more tags from the recognized text segments. Similarly, during transmission of the audio data tags may be extracted from the audio data by applying speech recognition process to the audio data to obtain text segments from the audio data and by retrieving one or more tags from the recognized text segments.

In embodiments of the invention retrieving of tags from the recognized text segments comprises comparing the recognized text segments from the processed audio and/or video data with the tags from the mapping previously stored on the storage facility 107 of the conference system 100 and then determining one or more tags corresponding to one or more of the recognized text segments.

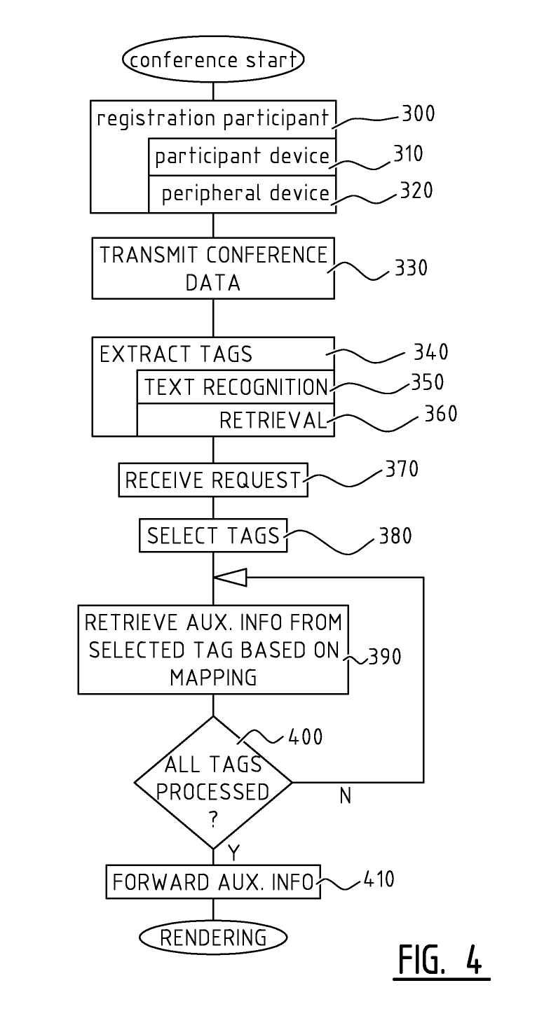

Referring to FIG. 4, when a user of a participant device 121 listening to the conference is in need of a further explanation about the content of the conference (i.e. the video data and/or the audio data), he may press a key (134) on the keyboard of the peripheral device 122. This causes the peripheral device 122 to generate a request for auxiliary information and transmit the request via the network 136 to the conference system 100. After having received (370) the request from the peripheral device, the conference system 100 determines which tags need to be selected (380) to provide the requesting participant 120 with relevant information. One option would be to determine the one or more tags extracted in a predefined time period before receipt of the request for auxiliary information. Any time period may be defined. Typically the conference system takes a time period over several seconds, for instance 5 to 10 seconds. The system then selects from the video data and/or audio data the tags that have been retrieved in this time period.

In embodiments of the invention the method also comprises transmitting the tags to the participant. The participant then chooses one or more tags from the tags presented and provides a selection signal to the conference system. The conference system then selects only the tahs that have been chosen by the participant. In a further embodiment the extracted tags to be transmitted to the participant are ranked in order to assist the participant to choose one or more suitable tags. These embodiments are examples of a selection that is based on participant preference. There are also other examples of selection based on participant's preferences.

In an embodiment the number of tags selected (380) from the tags extracted from video and/or audio data depends on the number of requests for auxiliary information received by the conference system by a specific participant and/or on the number of requests per unit of time (frequency). For instance, in case of a high number or high frequency of received requests for auxiliary information, more auxiliary information is transmitted to participant, while in case of a low number/frequency the system transmits less auxiliary information to the participant. Similarly, the user may determine whether the information need is low, medium or high. The level of information needed by a user may be provided as participant preference to the conference system. The conference system may be configured to provide more or less information or different types of information depending on the information need of the user (low, medium or high).

Auxiliary information portions corresponding to a selected tag are retrieved (390) from the storage 107 based on the mapping between this tag and one or more auxiliary information portions determined in the preprocessing phase. The system checks (410) whether all tags have been processed. When not all tags have been processed, the retrieval (390) of auxiliary information is repeated. When all tags have been processed, the auxiliary information received by the participant, for instance the peripheral device of the participant, is forwarded (pushed) (410) by the transmitter 177 to the transceiver 135 of the peripheral device 121 of the participant that has transmitted the request to the conference system. The auxiliary information pushed to the participant is rendered on the rendering device 131 of the participant 120, i.e. text, images and/or video's are displayed on the display device 132 and sound is played on the loudspeaker 133.

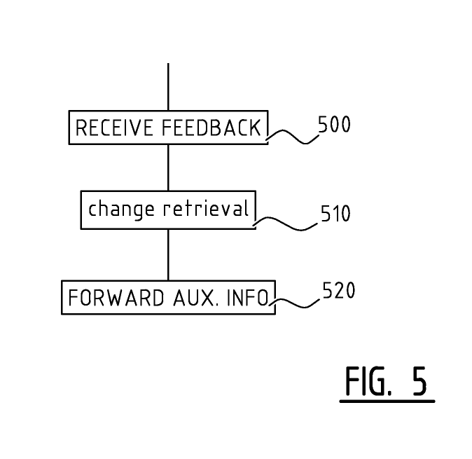

In FIG. 5 a further embodiment is presented. In this embodiment the participant provides feedback to the conference system based on the content of the previously received auxiliary information. The method comprises receiving (500) feedback data from the peripheral device in reaction to the auxiliary information pushed to the peripheral device. The conference system may determine to change (510) the retrieval of auxiliary information. For instance, the conference system may determine to stop retrieving information and pushing the information to the peripheral device when the user has given the feedback that the previously provided auxiliary information was not useful. The conference system may also decide to forward (push) (520) additional auxiliary information and/or more detailed auxiliary information to the peripheral device, based on the user preferences expressed in the feedback.

Since in this embodiment the auxiliary information is sent only to the participant that actually requested information, a user is presented only with auxiliary information that is relevant to him or her.

In the above embodiment the auxiliary information and the video data and audio data of the conference are displayed on separate displays, one for the actual video and/or audio of the video-conference and one for the auxiliary information. In other embodiments the auxiliary information and the video data and audio data of the conference are displayed on one single display (i.e. the first and second rendering device 125,131 are combined).

It is to be understood that this invention is not limited to particular aspects described, and, as such, may vary. It is also to be understood that the terminology used herein is for the purpose of describing particular aspects only, and is not intended to be limiting, since the scope of the present invention will be limited only by the appended clauses and the claims.

Clause 1. Method for tag based access to auxiliary information during a video- and/or audio-conference, the video- and/or audio conference involving a video- and/or audio conferencing system comprising a mapping between tags and associated portions of auxiliary information, the method comprising:
transmitting video data and/or or audio data from the video- and/or audio-conferencing system to participants of the video-conference;
extracting tags from the video data and/or audio data being transmitted;
upon receiving a request for auxiliary information from a participant:
   selecting at least one of the tags extracted from the transmitted video data and/or audio data;
   retrieving at least one auxiliary information portion associated with the selected at least one tag;
   transmitting the at least one retrieved auxiliary information portion to the participant that has requested the auxiliary information.

Clause 2. Method as defined in clause 1, wherein the extraction is performed during data transmittal of the video- and/or audio data.

Clause 3: Method as defined in any of the preceding clauses, the method comprising:
registering a peripheral device of a participant to the video- and/or audio-conferencing system;
transmitting the at least one retrieved auxiliary information portion to the registered peripheral device.

Clause 4: Method as defined in any of the preceding clauses, wherein selecting at least one of the tags extracted from the transmitted video data and/or audio data comprises:
determining the one or more tags extracted in a predefined time period before receipt of the request for auxiliary information.

Clause 4: Method as defined in any of the preceding clauses, wherein retrieving at least one auxiliary information portion associated with the selected at least one tag comprises:
comparing a selected tag with the mapping between the tags and associated portions of the auxiliary information;
determining the one or more auxiliary information portions corresponding to the selected tag.

Clause 5: Method as defined in any of the preceding clauses, wherein the selection of tags extracted from the transmitted video and/or audio data is based on participant preference.

Clause 6: Method as defined in any of the preceding clauses, wherein the number of tags selected from the tags extracted from video and/or audio data depends on the number and/or the frequency of received requests for auxiliary information.

Clause 7: Method as defined in any of the preceding clauses, wherein the number of tags selected from the tags extracted video and/or audio data depends on participant preference

Clause 8: Method as defined in any of the preceding clauses, comprising:
generating an auxiliary information request by the participant;
transmitting the auxiliary information request to the video- and/or audio-conferencing system.
Clause 9: Method as defined in any of the preceding clauses, comprising showing auxiliary information on a rendering device.

Clause 10: System for tag based access to auxiliary information in a video- and/or audio conference, the system comprising:
a storage unit configured to store auxiliary information, tags, and a mapping between the tags and associated portions of the auxiliary information;
a first transmitter for transmitting video data and/or or audio data to one or more participants of the conference;
a receiver for receiving a request for auxiliary information from one or more participants of the conference;
an extractor for extracting tags from the video data and/or audio data;
a retrieval unit for retrieving auxiliary information upon receipt of a request for auxiliary information by the receiver, the retrieval unit being configured to:
   select at least one of the tags extracted from the transmitted video data and/or audio data;
   retrieve at least one auxiliary information portion associated with the selected at least one tag;
a second transmitter for transmitting the retrieved auxiliary information portions to the participant that has requested the auxiliary information.

Clause 11. System as defined in clause 10, wherein the system is configured to:
rank the tags extracted from the video and/or audio data;
transmit the ranked tags to the participant;
receive from the participant a selection of the ranked tags;
retrieve the auxiliary information portion or portions from the selected tags.

Clause 12. System as defined in any of the clauses 10-11, wherein the system is configured to select tags extracted from the transmitted video and/or audio data based on participant preference, wherein the participant preference preferably is prestored on the system and/or is determined by the participant's behavior.

Clause 13: System as defined in any of clauses 10-12, wherein the number of tags selected from the tags extracted video and/or audio data depends on the number and/or the frequency of received requests for auxiliary information.

Clause 14: System as defined in any of the clauses 10-13, the system comprising a preprocessing unit configured to receive auxiliary information, process the received auxiliary information for obtaining one or more tags from the auxiliary information, mapping the obtained one or more auxiliary information tags to one or more associated portions of the auxiliary information and storing the auxiliary information, the tags, and the mapping between the tags and associated portions of the auxiliary information on the storage medium.

Clause 15: System as defined in clause 14, wherein the preprocessing unit is configured to:
apply text parsing and/or text summarization to the auxiliary information to obtain tags and their associated text portions of auxiliary information; and/or
collate tags by comparing the tags with a pre-stored compendium to augment the tags with synonyms and root forms; and/or
store the tags and the mapping with auxiliary information portions on the storage medium, preferably in a tag index or in at least one tag index file.

Clause 16: Assembly of the system as defined herein and one or more participants connected or connectable to the system through one or more telecommunication networks.

Clause 17: Assembly of clause 16, wherein a participant comprises a first unit comprising:
a first receiver for receiving video- and/or audio data;
a first rendering device for rendering the video- and/or audio data; and a second unit comprising:
a transmitter for transmitting an auxiliary information request signal?? to the receiver of the system;
a second receiver for receiving auxiliary information portions;
a second rendering device for rendering the auxiliary information portions.

As will be apparent to those of skill in the art upon reading this disclosure, each of the individual embodiments described and illustrated herein has discrete components and features which may be readily separated from or combined with the features of any of the other several embodiments without departing from the scope of the present invention. Any recited method can be carried out in the order of events recited or in any other order which is logically possible.

1. Method for tag based access to auxiliary information during a video- and/or audio-conference, the video- and/or audio conference involving a video-and/or audio conferencing system comprising a mapping between tags and associated portions of auxiliary information, the method comprising:
transmitting video data and/or or audio data from the video- and/or audio-conferencing system to participants of the video-conference;
extracting tags from the video data and/or audio data being transmitted;
upon receiving a request for auxiliary information from a participant:
selecting at least one of the tags extracted from the transmitted video data and/or audio data;
retrieving at least one auxiliary information portion associated with the selected at least one tag;
transmitting the at least one retrieved auxiliary information portion to the participant that has requested the auxiliary information.

2. Method as claimed in claim 1, wherein extracting tags from the audio data being transmitted comprises:
applying a speech recognition process to the audio data to obtain text segments from the audio data;
retrieving one or more tags from the recognized text segments; and/or wherein extracting tags from the video data being transmitted comprises:
applying a text recognition process to the video data to obtain text segments from the video data;
retrieving one or more tags from the recognized text segments.

3. Method as claimed in claim 1, wherein a mapping has been stored between tags and associated auxiliary information portions and wherein the retrieving of tags from the recognized text segments comprises:
comparing the recognized text segments from the processed audio and/or video data with the tags of the mapping;
determining one or more tags corresponding to one or more of the recognized text segments;
determining for each tag the associated auxiliary information portion or portions from the stored mapping.

4. Method as claimed in claim 1, comprising:
transmitting video data and/or audio data from the video- and/or audio-conferencing system to a first rendering device of the participant;
transmitting auxiliary information from the video- and/or audio-conferencing system to a second rendering device of the participant;
wherein the second rendering device preferably is a peripheral device, more preferably a mobile telecommunications device such as a telephone, smart phone or tablet device.

5. Method as claimed in claim 1, wherein selecting at least one of the tags extracted from the transmitted video data and/or audio data comprises:
determining the one or more tags extracted in a predefined time period before receipt of the request for auxiliary information; and/or the method comprising:
ranking the tags extracted from the video and/or audio data;
transmitting the ranked tags to the participant;
receiving from the participant a selection of the ranked tags;
retrieving the auxiliary information portion or portions from the selected tags; and/or the method comprising
generating an auxiliary information request by the participant;
transmitting the auxiliary information request to the video- and/or audio-conferencing system; and/or
showing auxiliary information on a rendering device.

6. Method as claimed in claim 1, wherein the selection of tags extracted from the transmitted video and/or audio data is based on participant preference; and/or wherein the number of tags selected from the tags extracted from video and/or audio data depends on the number and/or the frequency of received requests for auxiliary information.

7. Method as claimed in claim 1, wherein, in a pre-processing phase, the method comprises:
receiving at least one structured text document with tags and their associated auxiliary information portions; and/or wherein, in a pre-processing phase, the method comprises:
receiving auxiliary information by the video- and/or audio-conferencing system;
processing the received auxiliary information for obtaining one or more tags from the auxiliary information;
mapping the obtained one or more auxiliary information tags to one or more associated portions of the auxiliary information.

8. Method as claimed in claim 1, wherein processing the auxiliary information comprises:
applying text parsing and/or text summarization to the auxiliary information to obtain tags and their associated text portions of auxiliary information; and/or
collating tags by comparing the tags with a pre-stored compendium to augment the tags with synonyms and root forms; and/or
storing the tags and the mapping with auxiliary information portions in a tag index, preferably storing the tags in at least one tag index file on the video- and/or audio-conferencing system.

9. System for tag based access to auxiliary information in a video- and/or audio conference, the system comprising:
a storage unit configured to store auxiliary information, tags, and a mapping between the tags and associated portions of the auxiliary information;
a first transmitter for transmitting video data and/or or audio data to one or more participants of the conference;
a receiver for receiving a request for auxiliary information from one or more participants of the conference;
an extractor for extracting tags from the video data and/or audio data;
a retrieval unit for retrieving auxiliary information upon receipt of a request for auxiliary information by the receiver, the retrieval unit being configured to:
select at least one of the tags extracted from the transmitted video data and/or audio data;
retrieve at least one auxiliary information portion associated with the selected at least one tag;
a second transmitter for transmitting the retrieved auxiliary information portions to the participant that has requested the auxiliary information.

10. System as claimed in claim 9, wherein the extractor is configured to apply a speech recognition process to the audio data to obtain text segments from the audio data and to retrieve one or more tags from the recognized text segments and/or wherein the extractor is configured to apply a text recognition process to the video data to obtain text segments from the video data and to retrieve one or more tags from the recognized text segments; and/or wherein the retrieval unit is configured to compare the recognized text segments from the processed audio and/or video data with tags from the stored mapping, to determine one or more tags corresponding to one or more recognized text segments and to determine for each tag the associated auxiliary information portion or portions from the mapping stored on the storage medium.

11. System as claimed in claim 9, wherein the first transmitter is configured to transmit the video- and/or audio data to a first rendering device of the participant and the second transmitter is configured to transmit the retrieved auxiliary information portions to a second rendering device of the participant, wherein the second rendering device is preferably a peripheral device, more preferably a mobile telecommunications device, such as a telephone, smart phone or tablet device.

12. System as claimed in claim 9, wherein the retrieval unit is further configured to select at least one of the tags extracted from the transmitted video data and/or audio data by determining the one or more tags extracted in a prestored time period before receipt of the request for auxiliary information; and/or wherein the retrieval unit is configured to compare a selected tag with a mapping between the tags and associated portions of the auxiliary information and to determine the one or more auxiliary information portions corresponding to the selected tag.

13. System as claimed in claim 9, wherein the system is configured to select tags extracted from the transmitted video and/or audio data based on participant preference, wherein the participant preference preferably is prestored on the system and/or is determined by the participant's behavior and/or wherein the number of tags selected from the tags extracted video and/or audio data depends on the number and/or the frequency of received requests for auxiliary information.

14. System as claimed in claim 9, the system comprising a preprocessing unit configured to receive auxiliary information, process the received auxiliary information for obtaining one or more tags from the auxiliary information, mapping the obtained one or more auxiliary information tags to one or more associated portions of the auxiliary information and storing the auxiliary information, the tags, and the mapping between the tags and associated portions of the auxiliary information on the storage medium,
the preprocessing unit preferably being configured to:
apply text parsing and/or text summarization to the auxiliary information to obtain tags and their associated text portions of auxiliary information; and/or
collate tags by comparing the tags with a pre-stored compendium to augment the tags with synonyms and root forms; and/or
store the tags and the mapping with auxiliary information portions on the storage medium, preferably in a tag index or in at least one tag index file.

15. A computer program product comprising code for performing the method according to claim 1, when run on an electronic device, such as a computer.
